(19) United States
(12) Patent Application Publication
(10) Pub. No.: US 2014/0206486 A1
(43) Pub. Date: Jul. 24, 2014

(54) RADIALLY, AXIALLY, AND TORSIONALLY COMPLIANT SPROCKET

(71) Applicant: QINETIQ NORTH AMERICA, INC., McLean, VA (US)

(72) Inventors: Robert Fuchs, Wexford, PA (US); William Crowley, Pittsburgh, PA (US); Edward Mutschler, Wexford, PA (US)

(73) Assignee: QinetiQ North America, Inc., McLean, VA (US)

(21) Appl. No.: 13/748,820

(22) Filed: Jan. 24, 2013

(51) Int. Cl. F16H 55/14

(52) U.S. Cl. CPC F16H 55/14
USPC 474/161; 474/152

(57) ABSTRACT

A radially, axially, and torsionally compliant sprocket includes a rim including teeth thereon, a hub within the rim including a central bore, and a compliant open cell structure extending between the hub and the rim.

### FIELD OF THE INVENTION

This subject invention relates to sprockets.

### BACKGROUND OF THE INVENTION

U.S. Pat. No. 6,283,076, incorporated herein by this reference, describes a sprocket with an elastromeric member between a metal hub and a metal rim of the sprocket to render the sprocket torsionally compliant. U.S. Pat. No. 6,161,512, also incorporated herein by this reference, discloses another torsionally compliant sprocket with springs between the rim and the hub of the sprocket.

### SUMMARY OF THE INVENTION

In certain systems, a sprocket which is torsionally, radially, and even axially compliant is desired.

One example is a remotely controlled mobile robot driven by tracks via sprockets. Such robots are sometimes dropped or even thrown. The result can be damage or breakage of the sprocket or broken or damaged drive train components such as a bent or broken axle.

No known prior art provides a suitable sprocket which is torsionally, radially, and axially compliant.

A new sprocket is provided which, in one preferred embodiment, is axially, radially and torsionally compliant. When used as a component of a mobile remotely controlled robot, the robot can be dropped and the likelihood of damage to the sprocket or and drive train components is reduced.

This invention features a radially, axially, and torsionally compliant sprocket comprising a rim including teeth thereon, a hub within the rim including a central bore, and a compliant open cell structure extending between the hub and the rim.

In one version, the rim includes inwardly extending fingers and the compliant open cell structure engages the inwardly extending fingers of the rim. For example, the compliant open cell structure may include an elastomeric material over molded in the rim about the inwardly extending fingers. Typically, the elastomeric material includes rubber. The inwardly extending fingers of the rim may each include at least one orifice therethrough or some other feature for locking the compliant open cell structure to each inwardly extending finger.

In one embodiment, the compliant open cell structure includes crossing members. The rim may include fiberglass material. The hub may include keyways extending outwardly from the central bore. Typically, the hub and compliant open cell structure are unitary in construction.

A radially, axially, and torsionally compliant sprocket in accordance with the invention may feature a rim including teeth thereon and inwardly extending fingers, a hub within the rim including a bore, and a compliant structure over molded in the rim including portions engaging the inwardly extending fingers of the rim.

In one example, the compliant structure includes interlinked triangular structures each with a base integral with the hub and an apex engaging an inwardly extending finger.

In some examples the hub includes a molded body connected to the open cell structure and a hub reinforcement structure overmolded by the molded body. The reinforcement structure may include a socket extending outwardly. Typically, the socket includes a keyway therethrough. The reinforcement structure may include a cap attached to the socket encapsulated within the molded body and the preferred cap includes orifices therethrough for overmolding.

The molded body may have a shore hardness of between 80-90 A and be made of rubber. The reinforcement structure is preferably made of plastic, e.g., carbon filled nylon.

One radially, axially, and torsionally compliant sprocket in accordance with the invention features a molded rim including teeth thereon, a compliant molded open cell structure extending inwardly from the rim, and a hub connected to the open cell structure and including a molded body and a hub reinforcement structure overmolded by the molded body.

The invention also features a method comprising the use of a mold defining a rim with teeth extending therefrom, a hub having a central bore, and a compliant open cell structure between the hub and the rim. A reinforcement structure is placed in the mold. The reinforcement structure includes a cap with a socket extending therefrom. A compliant material is molded in the mold to form a sprocket such that a cap of the reinforcement structure is encapsulated within the hub of the sprocket.

The subject invention, however, in other embodiments, need not achieve all these objectives and the claims hereof should not be limited to structures or methods capable of achieving these objectives.

### BRIEF DESCRIPTION OF THE SEVERAL VIEWS OF THE DRAWINGS

Other objects, features and advantages will occur to those skilled in the art from the following description of a preferred embodiment and the accompanying drawings, in which:

FIG. 1 is a schematic three dimensional front view of an example of a torsionally compliant sprocket in accordance with the prior art;

FIG. 2 is a schematic partially cut away front view of another example of a prior art torsionally compliant sprocket;

FIG. 3 is a schematic front view of an example of a sprocket rim in accordance with the invention;

FIG. 4 is a schematic front view showing an example of a complete sprocket in accordance with the invention;

FIG. 5 is a schematic exploded front view showing a hub cap and a vehicle hub for use with the sprocket shown in FIG. 4;

FIG. 6 is a schematic three dimensional view showing an example of a remotely controlled mobile robot incorporating axially, radially, and torsionally compliant sprockets in accordance with the invention;

FIG. 7 is a schematic edge view of another example of a sprocket in accordance with the invention;

FIG. 8 is an exploded front view of the sprocket of FIG. 7;

FIG. 9 is a front schematic three dimensional rear view of the sprocket shown in FIGS. 7-8;

FIG. 10 is schematic a three dimension front view of the sprocket shown in FIGS. 7-9;

FIG. 11 is a schematic front view of the more rigid hub reinforcement structure shown in FIG. 10; and

FIG. 12 is a schematic cross sectional view of the reinforcer structure taken along lines 12-12 of FIG. 11.

### DETAILED DESCRIPTION OF THE INVENTION

Aside from the preferred embodiment or embodiments disclosed below, this invention is capable of other embodiments and of being practiced or being carried out in various ways. Thus, it is to be understood that the invention is not limited in its application to the details of construction and the arrangements of components set forth in the following description or illustrated in the drawings. If only one embodiment is described herein, the claims hereof are not to be limited to that embodiment. Moreover, the claims hereof are not to be read restrictively unless there is clear and convincing evidence manifesting a certain exclusion, restriction, or disclaimer.

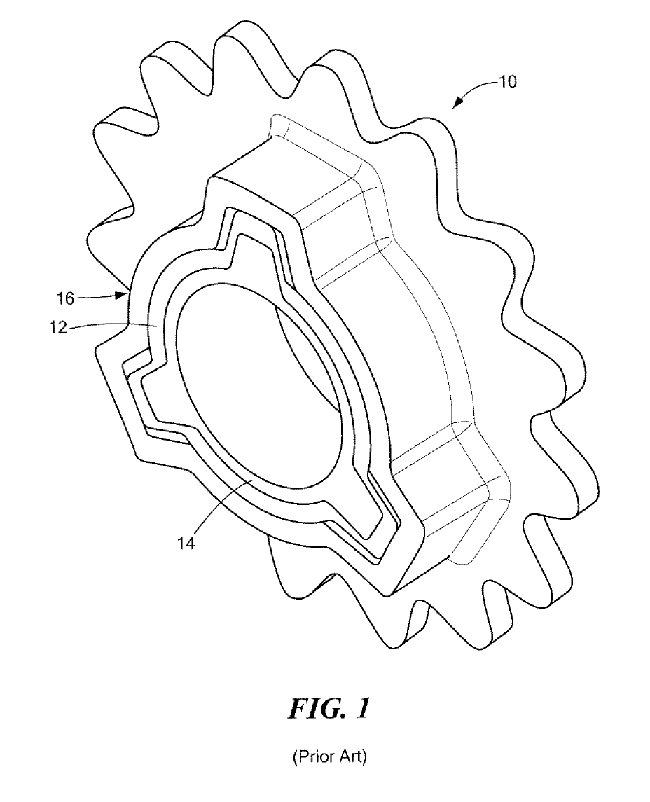

FIG. 1 shows sprocket 10 in accordance with U.S. Pat. No. 6,283,076. Elastromeric member 12 is disposed between metal hub 14 and metal rim 16 to render sprocket 10 torsionally compliant.

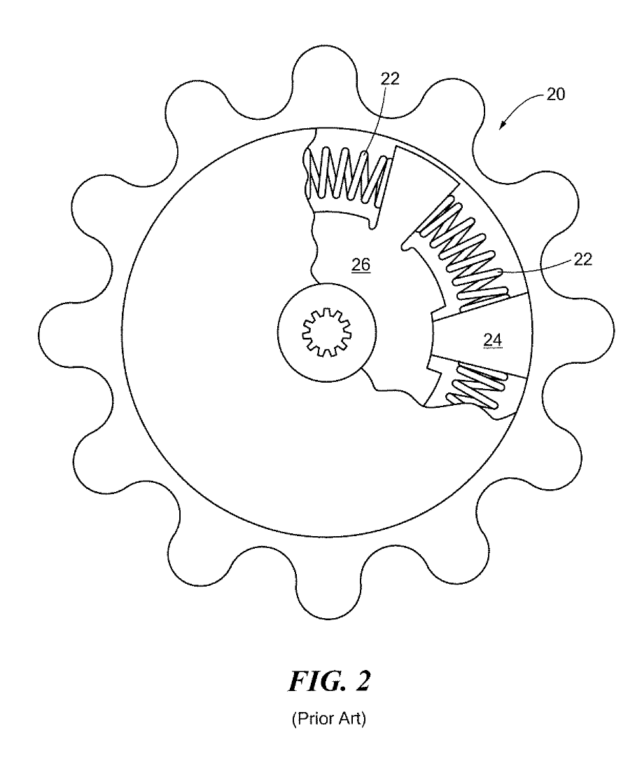

FIG. 2 shows another torsionally compliant sprocket 20 with springs 22 between rim 24 and hub 26 of the sprocket in accordance with U.S. Pat. No. 6,161,512.

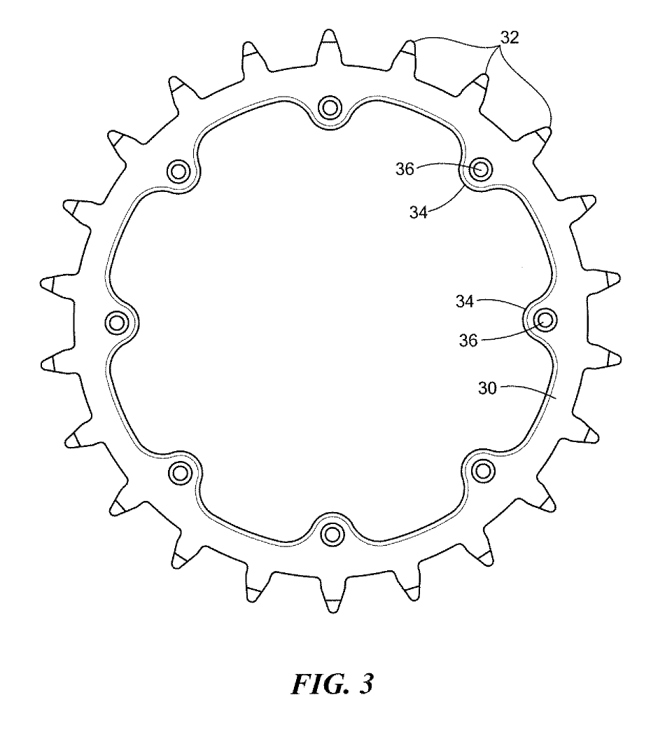

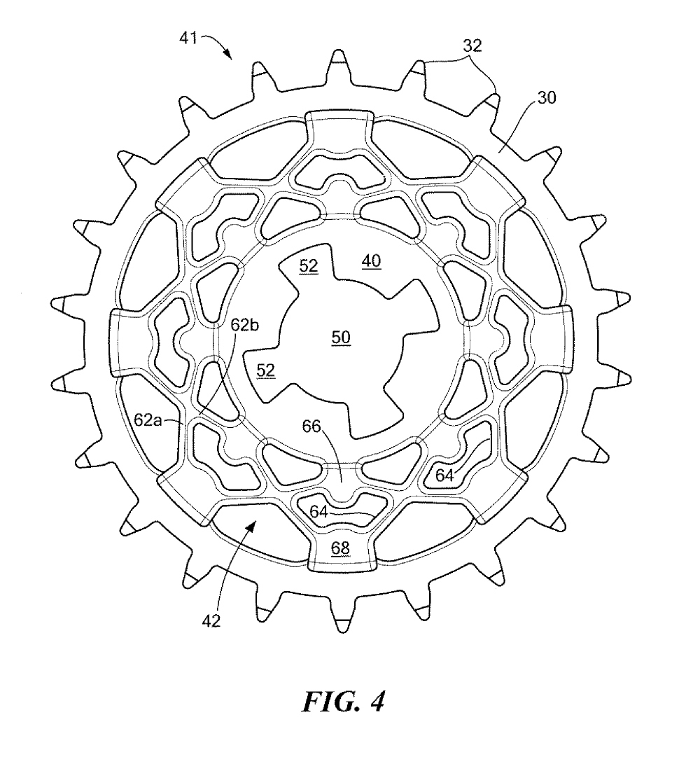

FIG. 3 shows an example of a sprocket rim 30 having teeth 32 thereon in accordance with the invention. Rim 30 and teeth 32 may be made of fiberglass material and may be machined into the configuration shown to include inwardly extending fingers 34 each with a feature such as orifice 36 therethrough. Over molded within rim 30 about fingers 34 and into orifices 36 is elastromeric sprocket hub 40, FIG. 4 and compliant open cell structure 42 extending between hub 40 and rim 30. The result is a radially, axially, and torsionally compliant sprocket 41. In one version, compliant open cell structure 42 is able to absorb impacts by deflecting up to ¼″ radially and up to ½″ axially. Torsionally, compliant open cell structure 42 is able to absorb impact loading which occurs during sudden starts and stops.

Hub 40 typically includes central bore 50 and may include keyways 52 extending outwardly from bore 50 as shown. Hub 40 and compliant open cell structure 42 are typically unitary in construction and made of an elastomeric material such as a thermoplastic elastomer rubber which engages inwardly extending fingers 34, FIG. 3 during the over molding process to lock the rubber material thereabout. The rubber material also flows within orifices 36 to lock structure 42 to rim 30.

Other compliant structures between hub 40, FIG. 4, are possible. In the configuration shown in FIG. 4, open cell compliant structure 42 includes crossing members 62a and 62b and defines interlinked triangular structures 64 each with a base 66 integral with hub 40 and an apex 68 locked to rim 30 about an inwardly extending finger 34, FIG. 3 thereof. Honeycomb or honeycomb like structures are possible as well. Hub 40 is typically less compliant and not an open cell structure since hub 40 mates with a vehicle hub.

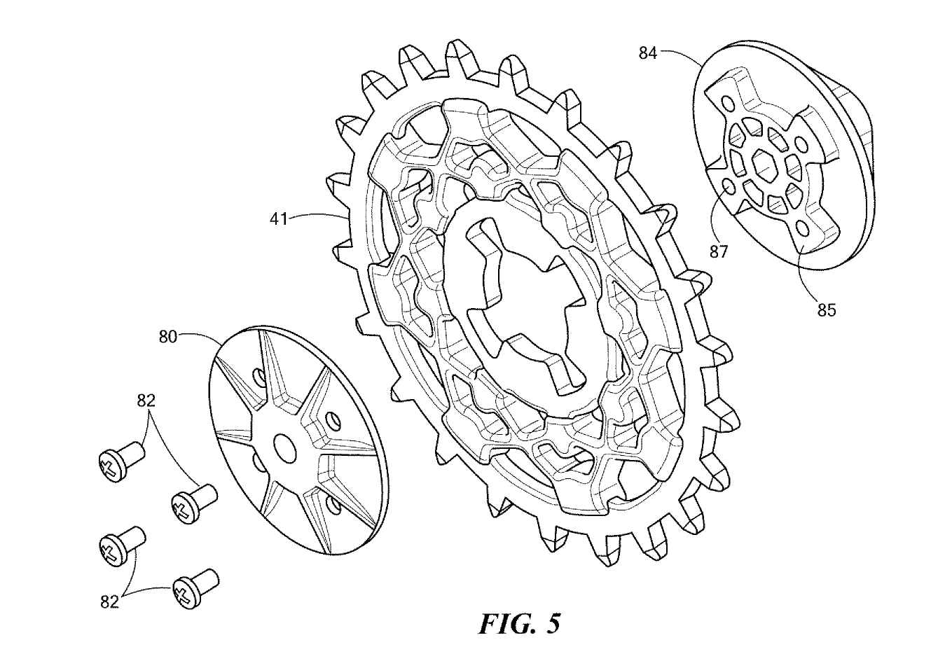

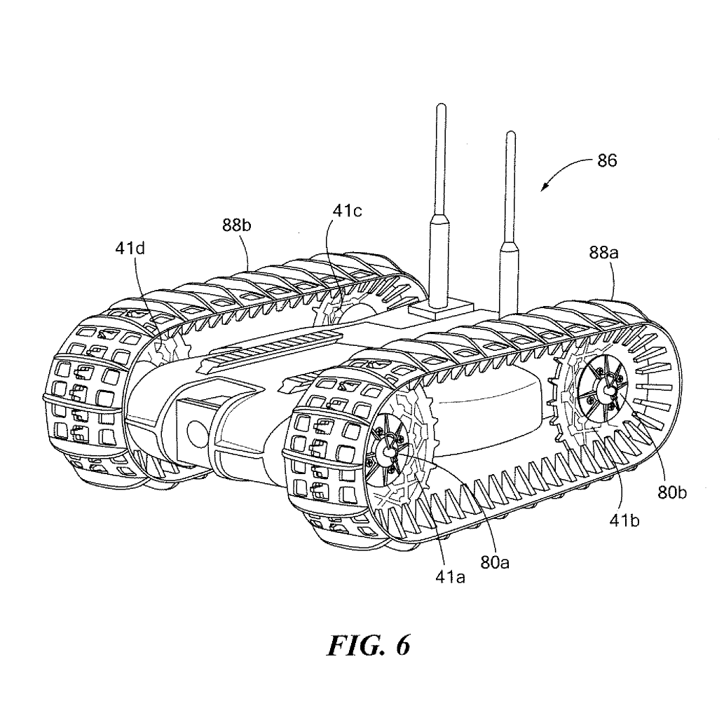

As shown in FIG. 5, sprocket 41 may be used in connection with hub cap 80 and fasteners 82 to secure sprocket 41 to vehicle hub 84 also shown in FIG. 6 where sprockets 41a-41d are used on robot 86 for treads 88a and 88b. Vehicle hub 84, FIG. 5, includes features 85 which lock into keyways 52 and fasteners 82 seat on hub cap 80 and extend into threaded orifices 87 in vehicle hub 84.

The result is a sprocket typically used with treaded vehicles that not only isolates the vehicle drive train from shock loads incurred during the course of driving the vehicle but which also absorbs impact loads that might otherwise damage the sprocket or the treaded vehicle. Shock loads can be experienced during acceleration and stopping the vehicle. Impact loads can be experienced during collisions as, for example, the vehicle runs into an obstacle at full speed or the vehicle is dropped, drops or falls. The shock absorbing sprocket of the invention is preferably created by combining a rigid sprocket with a flexible rubber shock absorber structure in an over molded assembly resulting in a single part that has a rigid edge for driving but is also flexible and compliant to absorb impacts. The open cell structure provides compliance, the solid structure of the hub provides the required rigidity to be able to mate with a vehicle hub, and the rim provides the required rigidity for driving a vehicle track.

Rim 30, FIG. 3, can be machined and then inserted into a mold where rubber is injection molded over rim 30 as shown in FIG. 4. In another example, rim 30 can be injection molded using a fiberglass filled plastic material and then placed in another mold to over mold rubber compliant structure 42.

Robot 86, FIG. 6, can now be dropped and even thrown and the likelihood of damage to sprockets 41a-41b and/or any drive train components of robot 86 (e.g., axles and the like) is reduced.

The material, compliance, hardness, and configuration of compliant open cell structure 42, FIG. 4, may vary as a function of the weight of the robot and its performance requirements, for example, how high of a drop it must sustain without damage. In one version, the robot weighed approximately 10 lbs and had to sustain a drop of 20 feet. The material used for complaint open cell structure 42 was polyurethane rubber with a hardness of 70 (Shore A). The configuration of the compliant open cell structure 42 was as shown in FIG. 4.

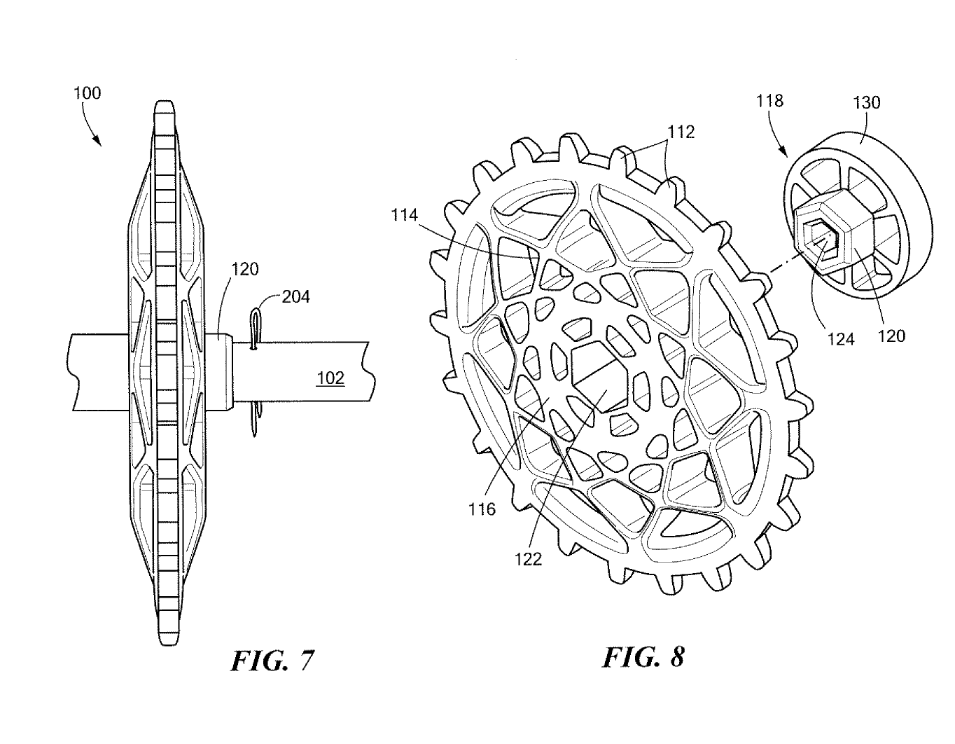

FIG. 7 depicts another example of a sprocket 100 easily mounted on robot axle 102 and retained by cotter pin 104. Here, rim 110, FIG. 8, teeth 112, compliant open cell structure 114, and somewhat compliant hub body 116 are all made of rubber (e.g., Santoprene TPV 201-87). Another component of the hub is more rigid and includes reinforcement structure 118 typically made of plastic (e.g., carbon filled nylon) over molded by the molded rubber component of hub body 116.

Reinforcer 118 includes, in one particular example, socket 120, FIGS. 7-10 hexagonal in shape received in hex opening 122 of rubber rub portion 116. Hex keyway 124 is formed in socket 120 for hex shaped axle 102, FIG. 7

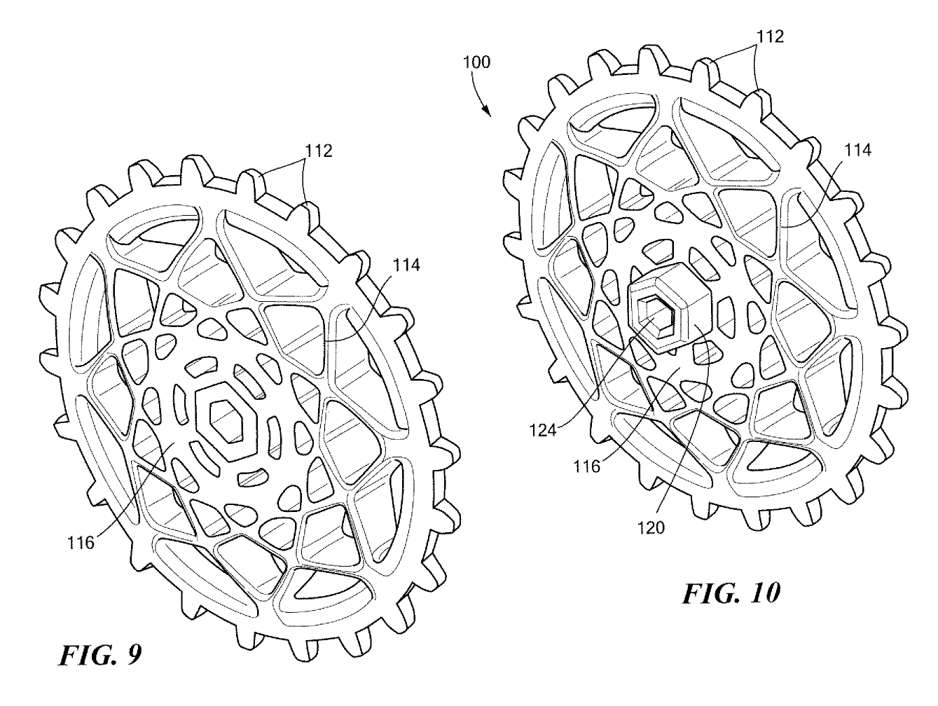

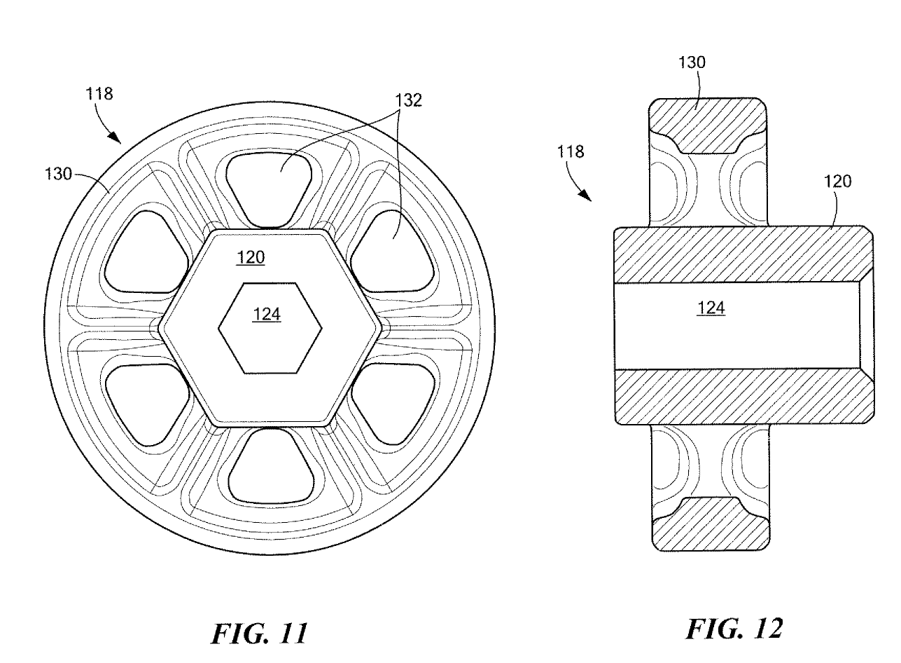

As shown more clearly in FIGS. 11-12, one version of the reinforcer 118 includes cap 130 attached to sprocket 120 and fully encapsulated within the hub 116, FIGS. 9-10, of the sprocket. Cap 130 includes six openings therethrough as shown at 132 for the over molding process in order to encapsulate cap 130 within the rubber hub. The molded rubber body, as noted above, is typically made of rubber and preferably has a shore hardness of between 80 to 90 (shore A). Reinforcer 118 is typically made of harder material, e.g., carbon filled nylon.

The compliancy, material, hardness, and configuration of open cell structure 114 may vary as a function of the weight of the robot and its performance requirements. Preferably the open cell structure isolates the vehicle drive train from shock loads incurred during the course of driving the vehicle and also absorbs impact loads that might otherwise damage the sprocket or treaded vehicle. In this example, the sprocket rim and opens cell structure connecting the sprocket rim to the sprocket hub are somewhat flexible and the sprocket hub is reinforced by a somewhat stiffer reinforcing structure connected to the vehicle axle.

Although specific features of the invention are shown in some drawings and not in others, however, this is for convenience only as each feature may be combined with any or all of the other features in accordance with the invention. The words “including”, “comprising”, “having”, and “with” as used herein are to be interpreted broadly and comprehensively and are not limited to any physical interconnection. Moreover, any embodiments disclosed in the subject application are not to be taken as the only possible embodiments.

In addition, any amendment presented during the prosecution of the patent application for this patent is not a disclaimer of any claim element presented in the application as filed: those skilled in the art cannot reasonably be expected to draft a claim that would literally encompass all possible equivalents, many equivalents will be unforeseeable at the time of the amendment and are beyond a fair interpretation of what is to be surrendered (if anything), the rationale underlying the amendment may bear no more than a tangential relation to many equivalents, and/or there are many other reasons the applicant can not be expected to describe certain insubstantial substitutes for any claim element amended.

Other embodiments will occur to those skilled in the art and are within the following claims.

What is claimed is:

1. A radially, axially, and torsionally compliant sprocket comprising:
a rim including teeth thereon;
a hub within the rim including a central bore; and
a compliant open cell structure extending between the hub and the rim.

2. The sprocket of claim 1 in which the rim includes inwardly extending fingers and the compliant open cell structure engages the inwardly extending fingers of the rim.

3. The sprocket of claim 2 in which the compliant open cell structure includes an elastromeric material over molded in the rim about the inwardly extending fingers.

4. The sprocket of claim 3 in which the elastromeric material includes rubber.

5. The sprocket of claim 2 in which the inwardly extending fingers of the rim each include at least one feature for locking the compliant open cell structure to each inwardly extending finger.

6. The sprocket of claim 1 in which the compliant open cell structure includes crossing members.

7. The sprocket of claim 1 in which the rim includes fiberglass material.

8. The sprocket of claim 1 in which the hub includes keyways extending outwardly from the central bore.

9. The sprocket of claim 1 in which the hub and compliant open cell structure are unitary in construction.

10. The sprocket of claim 1 in which the hub includes a molded body connected to the open cell structure and a hub reinforcement structure overmolded by the molded body.

11. The sprocket of claim 10 in which the reinforcement structure includes a socket extending outwardly.

12. The sprocket of claim 11 in which the socket includes a keyway therethrough.

13. The sprocket of claim 11 in which the reinforcement structure includes a cap attached to the socket encapsulated within the molded body.

14. The sprocket of claim 13 in which the cap includes orifices therethrough for overmolding.

15. The sprocket of claim 10 in which the molded body has a shore hardness of between 80-90 A.

16. The sprocket of claim 15 in which the molded body is made of rubber.

17. The sprocket of claim 10 in which the reinforcement structure is made of plastic.

18. The sprocket of claim 17 in which the reinforcement structure is made of carbon filled nylon.

19. A radially, axially, and torsionally compliant sprocket comprising:
a molded rim including teeth thereon;
a compliant molded open cell structure extending inwardly from the rim; and
a hub connected to the open cell structure and including a molded body and a hub reinforcement structure overmolded by the molded body.

20. The sprocket of claim 19 in which the reinforcement structure includes a socket extending outwardly.

21. The sprocket of claim 20 in which the socket includes a keyway therethrough.

22. The sprocket of claim 20 in which the reinforcement structure includes a cap attached to the socket encapsulated within the molded body.

23. The sprocket of claim 22 in which the cap includes orifices therethrough for overmolding.

24. The sprocket of claim 19 in which the molded body has a shore hardness of between 80-90 A.

25. The sprocket of claim 19 in which the molded body is made of rubber.

26. The sprocket of claim 19 in which the reinforcement structure is made of plastic.

27. The sprocket of claim 26 in which the reinforcement structure is made of carbon filled nylon.

28. A method comprising:
a mold defining a rim with teeth extending therefrom, a hub having a central bore, and a compliant open cell structure between the hub and the rim;
placing a reinforcement structure in the mold, the reinforcement structure including a cap with a socket extending therefrom; and
molding a compliant material in the mold to form a sprocket such that a cap of the reinforcement structure is encapsulated within the hub of the sprocket.

29. The method of claim 28 in which the socket includes a keyway therethrough.

30. The method of claim 28 in which the cap includes orifices therethrough for over molding.

31. The method of claim 28 in which the compliant material has a shore hardness of between 80-90 A.

32. The method of claim 28 in which the compliant material is rubber.
